(19) United States
(12) Patent Application Publication
(10) Pub. No.: US 2008/0178458 A1
(43) Pub. Date: Jul. 31, 2008

(54) GOLF CLUB HEAD JOINING METHOD

(75) Inventors: Chun-Kai HSU, Fongshan City (TW); Ying-Sen HSU, Kaohsiung City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: ADVANCED INTERNATIONAL MULTITECH CO.,LTD, KKAOHSIUNG CITY (TW)

(21) Appl. No.: 11/960,233

(22) Filed: Dec. 19, 2007

(30) Foreign Application Priority Data
Jan. 26, 2007 (TW) 096103075

(51) Int. Cl. B23K 1/20

(52) U.S. Cl. 29/525.14; 29/527.2; 228/208

(57) ABSTRACT

A golf club head joining method is provided, which utilizes a soldering joining process to assemble the golf club head. The joining method includes the steps of providing a first component and a second component, wherein the first and second components are made of metal materials; subsequently, the step of applying a coating of active metal or compounds suitable to be affixed with a soldering metal material on the first component and the second component; and the last step of finally joining the first component to the second component, enabling the two to become one. Therefore, the joining method enables the joining of the golf club head not to be restricted to the use of certain materials and enhances the joint strength without incurring additional costs or complicating the manufacturing process.

### BACKGROUND OF THE INVENTION

1. Field of the Invention

The present invention relates to a golf club head joining method, particularly to a joining method that enables the golf club head joint by utilizing available soldering metal materials on the market.

2. Description of Related Art

Conventional methods for joining a golf club head body with a ball striking surface are employing an adhering method to join the two, or a fitting method wherein a golf club head body and a ball striking surface are designed to be operatively coupled into one body by applying an external force to join or interlock the two.

However, both the adhering method and fitting method have many drawbacks. For example, the adhering method facilitates the joining of a golf club head body and a ball striking surface, nevertheless, the method is unable to realize the appearance of being finished after the golf club head body and the ball striking surface glued into one because of exposed glued area. Therefore cladding is additionally required as the final process, which can only be done once the whole golf club head is composed of conductive metal. If cladding is carried out separately, it will be impossible to address the cladding planarity problem of the whole exterior. Moreover, there will be the disadvantages of a complicated manufacturing process and raised costs. Similarly, the fitting method requires applying putty on the gaps for a more complete appearance. However, the cladding process conceals gaps poorly with all of them remaining visible on the exterior.

Furthermore, a soldering process may be used for joining a golf club head body with a ball striking surface, but a soldering metal material must simultaneously affix to both materials of the body and the ball striking surface. It is time consuming to search for or develop new soldering metal materials that conform to requirements, thus limiting the applications of a soldering process to the joining operation of the golf club head, with the solder material incurring several additional costs.

Consequently, a conventional golf club head joint is restricted by certain soldering metal materials. This lack of a more effective joining method for a golf club head creates a great need for one.

### SUMMARY OF THE INVENTION

In view of these problems associated with conventional techniques, the present invention for a golf club head joining method is disclosed hereafter to solve the appearance defect problem due to conventional golf club head joining methods without increasing additional costs for finding suitable soldering metal material for the joining process.

To achieve this objective, the present invention provides a golf club head joining method which utilizes a solder joining process comprising the step of providing a first component, the step of providing a second component, the step of applying a coating of active metal or compounds suitable to be affixed with a soldering metal material on the first component and the second component, and finally joining the first component to the second component. First, manufacture the first component from a metal material and give it a joining surface. Next, manufacture the second component also from a metal material and give it a joining surface. Then, apply a coating of active metal or compounds suitable to be affixed with a soldering metal material on the first component and the second component. Finally, attach the first component to the second component, completely affixing the first component to the second component and adding the soldering metal material for the joining of the two. Begin the heating process on the first component and the second component to melt the soldering metal material into the attached surface between the first component and the second component, thereby joining the first component and the second component together.

The present invention of this golf club head joining method achieves the following effects:

To realize the objectives, the present invention discloses a golf club head joining method by utilizing a solder joining process, wherein a coating of active metal or compounds suitable to be affixed with a soldering metal material is applied for a joining operation. Therefore, it is not necessary to spend time searching for or developing new soldering metal materials, thus the joining operation is not restricted by the solder material and significant time and costs are saved. Moreover, the present invention more effectively utilizes materials that have largely varying melting points such that there are no limitations to what kind of materials can be used in golf club heads. In addition, as the work piece is coated by a layer of active metal or compounds for protection, the subsequent golf club head soldering process is therefore only required to be protected by inert gas to avoid high temperatures and oxidation.

A detailed description of the objectives, composition and traits of the present invention is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a flow chart showing a preferred embodiment of a golf club head joining method of the present invention;

FIG. 2 is an illustrative view of a first embodiment showing a completely joined golf club head in accordance with the golf club head joining method of the present invention;

FIG. 3 is an illustrative view of a second embodiment showing a completely joined golf club head in accordance with the golf club head joining method of the present invention; and

FIG. 4 is an illustrative view of a third embodiment showing a completely joined golf club head in accordance with the golf club head joining method of the present invention.

### DETAILED DESCRIPTION OF THE INVENTION

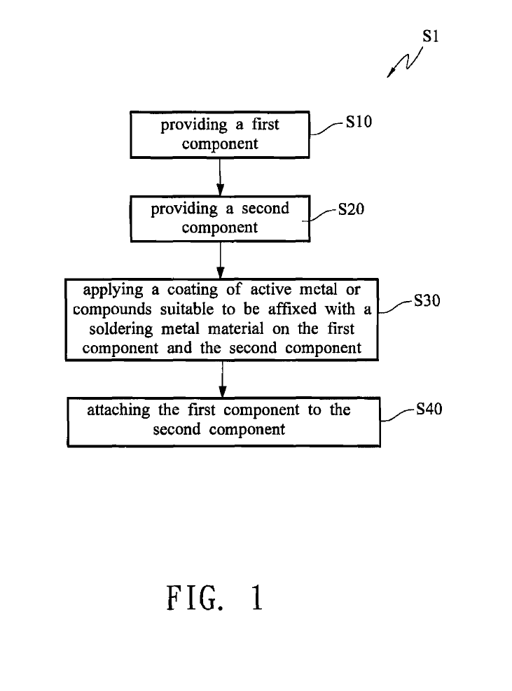

Referring to FIG. 1, there is an illustration of the joining process of the present invention for a golf club head joining method that utilizes a solder joining process. A golf club head joining method S1 showing that a first preferred embodiment comprises the steps of providing a first component (Step S10), providing a second component (Step S20), applying a coating of active metal or compounds suitable to be affixed with a soldering metal material on the first component and the second component (Step S30), and finally joining the first component to the second component (Step S40).

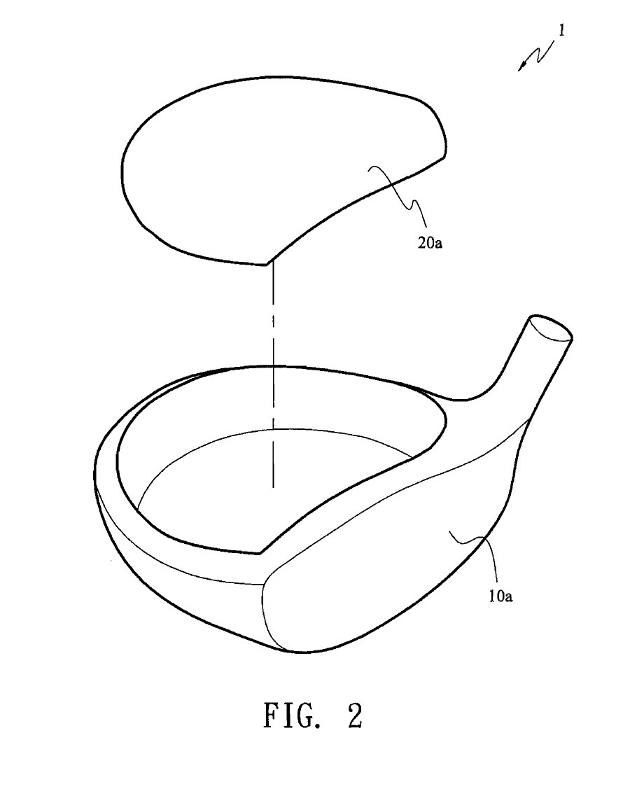

Referring to FIGS. 1 and 2, the present invention provides a golf club head joining method utilizing a solder joining process. The first preferred embodiment of the golf club head joining method S1 initially offers the first component (Step S10), in which the first component 10a is made of a metal material with a joining surface, to be more specific, the first component 10a is made of a metal with a high-melting-point. In addition, method S1 offers the second component (Step S20), in which the second component 20a (e.g., a golf club head top, a frame border or a ball striking surface as subsequently described) is made of a metal material with a joining surface and a low-melting-point. The high-melting-point metal is defined as metal with a melting point above 700 Celsius degrees capable of undergoing welding and brazing, whereas the low-melting-point metal has a melting point below 700 Celsius degrees and is suited for being processed under the temperature scope of the soldering process. Furthermore, the first component 10a in the first preferred embodiment is a main body, whereas the second component 20a is a golf club head top. Subsequently, a coating of active metal or compounds suitable to be affixed with a soldering metal material is applied on the first component and the second component (Step S30), such that the surfaces of both the first component 10a and the second component 20a are coated with a layer of active metal or compounds capable of being affixed with the soldering metal material for joining. The referred embodiment shows that the surface thickness of the active metal or compound coating on the first component 10a and the second component 20a is 0.5 μm˜50 μm. In addition, the active metal may be nickel, silver, copper and gold, and the compound is one of metal compound from nitrides, oxides or carbides, such as nickel nitride, nickel carbide or nickel oxide; silver nitride, silver carbide or silver oxide; copper nitride, copper carbide or copper oxide; or gold nitride, gold carbide or gold oxide. Moreover, the melting point of the soldering metal material is lower than that of the second component 20a. Finally, the first component and the second component are joined (Step S40), adding the soldering metal material in order to join the first component 10a to the second component 20a. The heating process is carried out on the first component 10a and the second component 20a, enabling the soldering metal material to be melted into the joined surface between the first component 10a and the second component 20a, thereby joining the first component and the second component together as a golf club head 1.

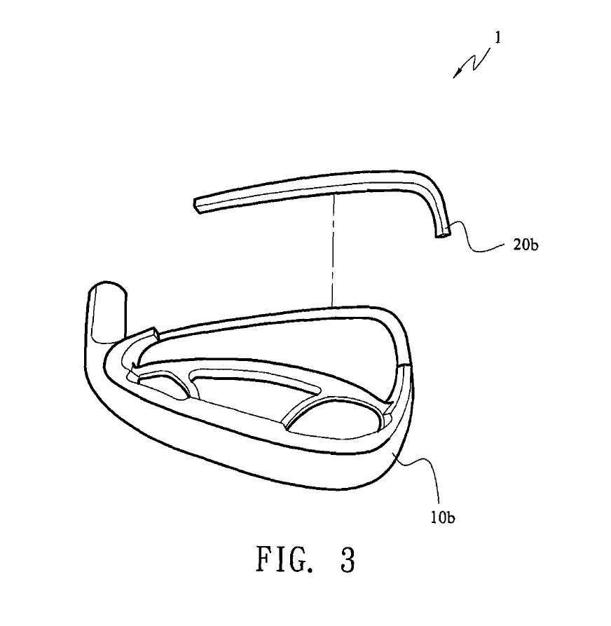

FIG. 3 illustrates a second preferred embodiment of the golf club head joining method S1, in which a first component 10b is a frame body and a second component 20b is also a frame border. The method S1 utilizes the aforementioned steps to join the first component to the second component to form the golf club head 1.

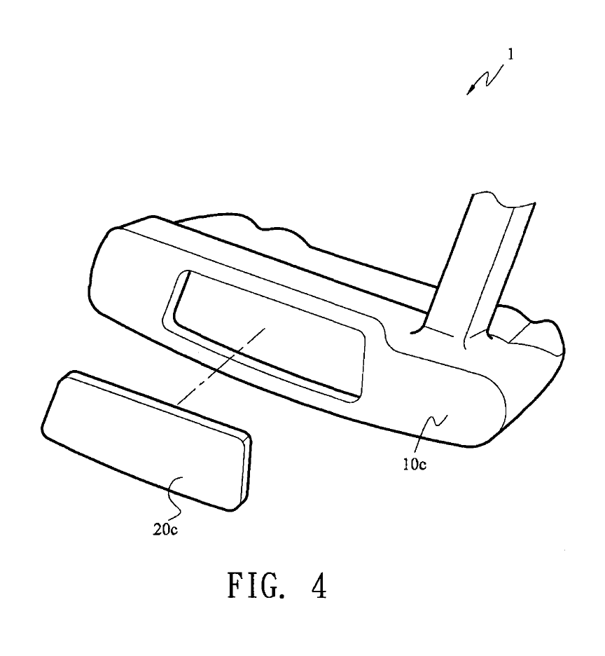

FIG. 4 illustrates a third preferred embodiment of the golf club head joining method S1, wherein a first component 10c is a main body and a second component 20c is a ball striking surface. The method S1 utilizes the aforementioned steps to attach the first component to the second component to form the golf club head 1.

Moreover, the first components 10a and 10c are also able to respectively be a golf club head top or a ball striking surface, where the second components 20a and 20c also able to respectively be the main bodies of each, and where the first component 10b and the second component 20b are respectively a frame border and a frame body.

In addition, a third preferred embodiment of the golf club head joining method S1 shows that the first component 10a is low-melting-point metal and the second component 20a is high-melting-point metal. The method S1 utilizes the steps to join the first component to the second component as the golf club head 1, in which the melting point of the soldering metal material is lower than that of the first component 10a.

The first components 10a, 10b and 10c and the second components 20a, 20b and 20c are heated with a laser, a gas flame gun or an infrared heat gun, or the first components 10a, 10b and 10c and the second components 20a, 20b and 20c are heated in a continuous furnace or a gas furnace by inert gas injection, here the inert gas may be nitrogen, argon or helium. The first components 10a, 10b and 10c and the second components 20a, 20b and 20c are heated by inert gas injection, so that the soldering metal material is able to be melted into the first components 10a, 10b and 10c and the second components 20a, 20b and 20c without causing oxidation during the joining process, thereby enabling the first components 10a, 10b and 10c and the second component 20a, 20b and 20c to be joined together. In addition, the first components 10a, 10b and 10c and the second components 20a, 20b and 20c can be able to be heated in a vacuum furnace under vacuum conditions.

For the application of a coating of active metal or compounds suitable to be affixed with a soldering metal material on the first component and the second component (Step S30), the surfaces of the first components 10a, 10b and 10c and the second components 20a, 20b and 20c are coated via physical vapour deposition (PVD) method, chemical vapor deposition (CVD) method, electroplating coating method, electroless plating method, and thermal spray method. Moreover, the soldering metal material may be lead, zinc, indium, antimony or tin, where the metals are made of solid-state soldering sheet, soldering rod or semi-liquid solder paste.

While the present invention has been described by way of example and in terms of the preferred embodiment, it is to be understood that the present invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A golf club head joining method, utilizing a soldering joining process for club head joint, comprising the steps of:
providing a first component, which is made of a metal material and has a joining surface;
providing a second component, which is made of a metal material and has a joining surface;
applying a coating of active metal or compounds suitable to be affixed with a soldering metal material on said first component and said second component; wherein the surfaces of said first component and said second component are respectively coated with the layer of active metal or compounds capable of being affixed by said soldering metal material for joining; and
joining said first component and said second component, to join together said first component and said second component by adding said soldering metal material and then carrying out a heating process on said first component and said second component, to enable said soldering metal material to be melted into said joining surfaces between said first component and said second component, thereby joining said first component and said second component together.

2. The golf club head joining method as claimed in claim 1, wherein said first component is a high-melting-point metal and said second component is a low-melting-point metal, wherein the melting point of said soldering metal material is lower than that of said second component.

3. The golf club head joining method as claimed in claim 1, wherein said first component is a low-melting-point metal and said second component is a high-melting-point metal, wherein the melting point of said soldering metal material is lower than that of said first component.

4. The golf club head joining method as claimed in claim 1, wherein said first component and said second component are heated by a laser, a gas flame gun or an infrared heat gun.

5. The golf club head joining method as claimed in claim 1, wherein said first component and said second component are heated in a gas furnace or a continuous furnace by inert gas injection.

6. The golf club head joining method as claimed in claim 5, wherein said inert gas is selected from the group consisting of nitrogen, argon and helium.

7. The golf club head joining method as claimed in claim 1, wherein said first component and said second component are heated in a vacuum furnace under vacuum conditions.

8. The golf club head joining method as claimed in claim 1, wherein said first component is a main body and said second component is a golf club head top or a ball striking surface.

9. The golf club head joining method as claimed in claim 1, wherein said first component is a golf club head top or a ball striking surface and said second component is a main body.

10. The golf club head joining method as claimed in claim 1, wherein said first component and said second component respectively are a frame body and a frame border.

11. The golf club head joining method as claimed in claim 1, wherein said first component and said second component respectively are a frame border and a frame body.

12. The golf club head joining method as claimed in claim 1, wherein said active metal is selected from the group consisting of nickel, silver, copper and gold.

13. The golf club head joining method as claimed in claim 1, wherein said compounds are nickel nitride, nickel carbide or nickel oxide.

14. The golf club head joining method as claimed in claim 1, wherein said compounds are silver nitride, silver carbide or silver oxide.

15. The golf club head joining method as claimed in claim 1, wherein said compounds are copper nitride, copper carbide or copper oxide.

16. The golf club head joining method as claimed in claim 1, wherein said compounds are gold nitride, gold carbide or gold oxide.

17. The golf club head joining method as claimed in claim 1, wherein said soldering metal material is selected from the group consisting of lead, zinc, indium, antimony and tin.

18. The golf club head joining method as claimed in claim 1, wherein said step of applying a coating of active metal or compounds suitable to be affixed with a soldering metal material on said first component and said second enables the surface thickness of said active metal or compound coating on said first component and said second component to be 0.5 μm to 50 μm.

19. The golf club head joining method as claimed in claim 1, wherein said step of applying a coating of active metal or compounds suitable to be affixed with a soldering metal material on said first component and said second component utilizes coating methods which are physical vapour deposition (PVD) method, chemical vapor deposition (CVD) method, electroplating method, electroless plating method or thermal spray method.

20. The golf club head joining method as claimed in claim 1, wherein said soldering metal material is a solid-state soldering sheet, a soldering rod or a semi-liquid solder paste.
